(19) United States
(12) Patent Application Publication
(10) Pub. No.: US 2011/0264353 A1
(43) Pub. Date: Oct. 27, 2011

(54) MODEL-BASED OPTIMIZED ENGINE CONTROL

(76) Inventors: Christopher M. Atkinson, Morgantown, WV (US); Marc C. Allain, Plymouth, MI (US); Alexander Kroop, Stuttgart (DE)

(21) Appl. No.: 12/765,612

(22) Filed: Apr. 22, 2010

(51) Int. Cl. F02D 28/00; G06F 15/18

(52) U.S. Cl. 701/102; 706/14

(57) ABSTRACT

An internal combustion engine controller having at least one forward engine model, at least one inverse control model that employs at least one neural network, at least one physical engine sensor input, at least one predetermined control input and at least one output, wherein the inverse modeling determines and calculates the at least one control input.

### BACKGROUND OF THE INVENTION

Over the past decade, regulated emissions compliance has driven the development of electronic engine control for internal combustion engines. Low emission, high efficiency internal combustion engines continue to increase in sophistication with a rapid proliferation of additional engine sensors and control actuators. This complexity increases the number of independently controllable parameters and calibration variables, which in turn increases the control system development burden. Current algorithm-based engine controls generally focus on fuel injection strategies, air path control, exhaust gas recirculation (EGR) and after-treatment management. Due to the complex dynamic interactions between these control parameters, effective strategies are difficult to develop from a first-principles' basis and time-consuming to calibrate under transient real-world operation.

Conventional engine control involves the development of multiple functions and algorithms to control air management, exhaust management, fuel injection, and active after-treatment control. Diesel engine control today is predominantly feed-forward open loop control with hundreds or thousands of independent calibrateable parameters or pre-mapped data points. Feed-forward open loop control is also susceptible to the effects of extraneous disturbances or noise, sensor drift and general degradation of sensors and actuators. As a result conventional engine control requires a significant, ongoing effort in function development and downstream engine calibration using expensive engineering resources. Consequently, significant control tuning is required for control system development and optimization, as this mode of control is well-suited for steady state operation, and not for the transients that characterize real-world engine operation.

The pressure to improve engine control is based on the desire to improve real-world fuel efficiency while maintaining the same or reduced emissions levels, improving dynamic engine performance and reducing the accompanying calibration, diagnostics and prognostics burden in order to reduce engineering effort and costs. An alternative approach for engine control is model-based control. Model-based calibration optimization methods have shown their efficacy in the off-line engine development process but have had minimal success in on-line, real time engine controls.

### BRIEF DESCRIPTION OF THE DRAWINGS

FIG. 1 is an illustration of an internal combustion engine control system;

FIG. 2 is an illustration of an internal combustion engine control method;

FIG. 3 illustrates a predicted carbon dioxide output using real-time dynamic engine modeling;

FIG. 4 illustrates the predicted nitrogen oxide output using the real-time dynamic engine modeling;

FIG. 5 illustrates the predicted carbon monoxide output using the real-time dynamic engine modeling;

FIG. 6 illustrates a predicted engine smoke output using the real-time dynamic engine modeling;

FIG. 7 illustrates a predicted carbon dioxide output using real-time dynamic engine modeling;

FIG. 8 illustrates the predicted exhaust gas recirculation rates using the real-time inverse modeling;

FIG. 9 illustrates the predicted pilot injection quantities using the real-time inverse modeling;

FIG. 10 illustrates the predicted injection timing using the real-time inverse modeling;

FIG. 11 illustrates the predicted injection pressure using the real-time inverse modeling;

FIG. 12 illustrates a low nitrogen oxide emissions;

FIG. 13 illustrates a high nitrogen oxide emissions; and

FIG. 14 illustrates that a real-time optimizer reduces nitrogen oxide emissions levels by demanding higher exhaust gas recirculation levels.

### DETAILED DESCRIPTION OF THE INVENTION

Referring now to the discussion that follows and to the drawings, illustrative approaches to the disclosed systems and methods are described and shown in detail. Although the drawings represent some possible approaches, the drawings are not necessarily to scale and certain features may be exaggerated, removed, or partially sectioned to better illustrate and explain the disclosed device. Further, the descriptions set forth herein are not intended to be exhaustive or otherwise limit or restrict the claims to the precise forms and configurations shown in the drawings and disclosed in the following detailed description.

Model-based control (MBC) systems may be generally implemented in connection with an internal combustion engine (e.g., a compression ignition or diesel engine) having multiple inputs, such as, but not limited to, rotational speed as measured in revolutions per minute (RPM), fueling rate, exhaust gas recirculation (EGR) rate, airflow rate, injection timing (BOI), injection pressure, intake temperature, intake pressure, RPM gradient and fueling rate gradient. MBC systems may be used as a means of controlling turbocharged diesel engines with variable geometry turbocharging (VGT) and EGR due to the difficulties of predicting and controlling turbocharger response using conventional table-based control methods. MBC methods may also be used to improve an engine calibration process, again as an alternative to conventional map (look-up tables, LUT) or table-based methods.

The development of an MBC system may include high fidelity dynamic engine models, which may predict engine performance, emissions and operating states at high computational rates. These dynamic models are based on a combination of physics-based modeling and data-driven techniques, which are used for both a forward and an inverse prediction. Physics-based models are based on first principle physics, chemical and thermodynamic equations. An exemplary MBC system allows for adaptation to compensate for fuel property variations, sensor drift and engine sensor actuator degradation, which may reduce the effort required for the calibration optimization of highly complex engines.

An exemplary MBC system may include, but is not limited to scalability, expandability, elimination of utilizing the map configuration, intrinsic robustness, optimization of performance, predictive strategies, adaptive strategies, real-time feedback, utilization of on-board optimizer, minimization of calibration and integration of on-board diagnostic (OBD) requirements. Exemplary MBC systems may control the engine using a multi-dimensional, non-linear dynamic model.

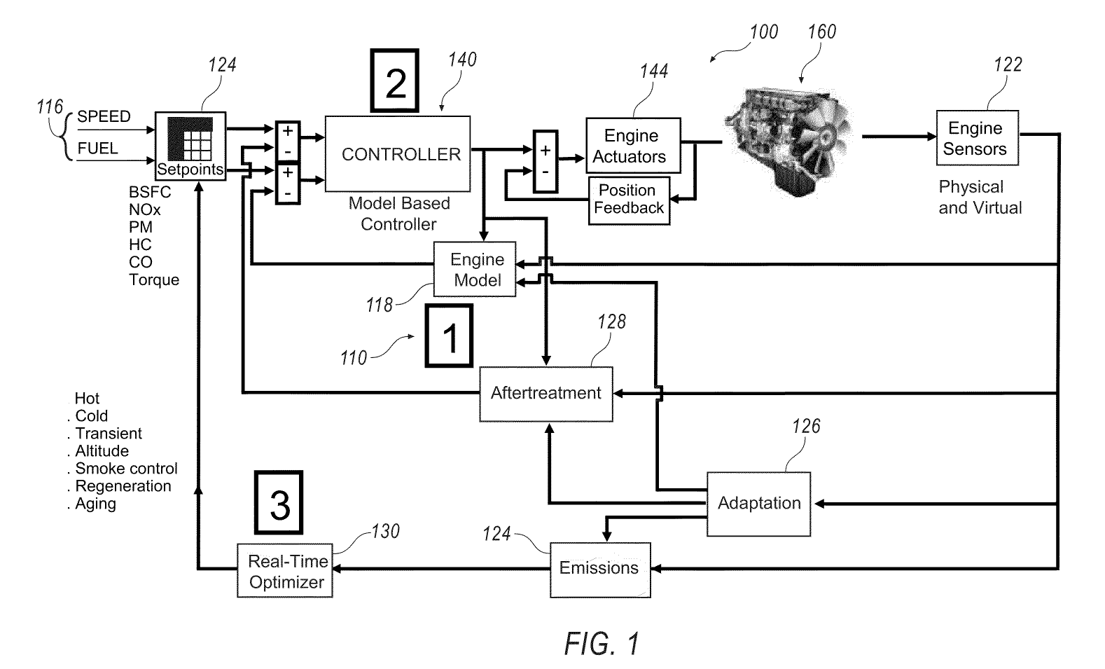

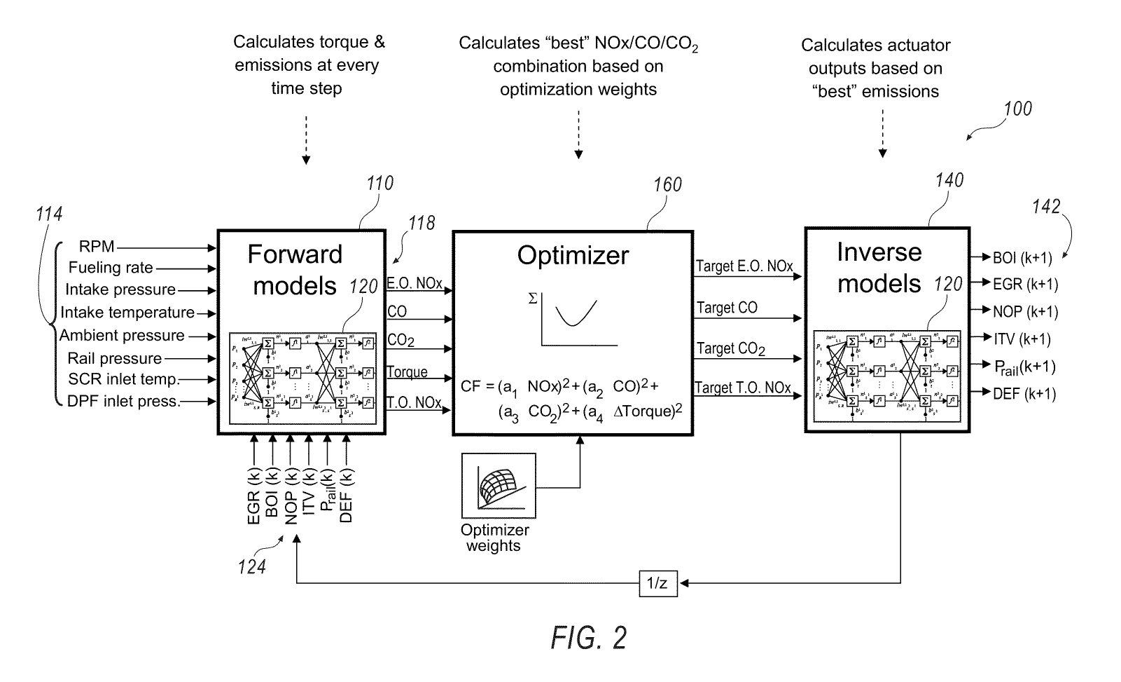

Turning now to FIGS. 1 and 2, an exemplary next generation model-based engine control system 100 is illustrated. The exemplary MBC system 100, as illustrated, shows the three main components, a real-time dynamic predictive engine model 110, a model-based controller 140 and a real-time optimizer 160.

The real-time dynamic predictive engine model 110 is a forward model that may predict engine performance, engine operation, engine emissions 124 and engine response for a given set of transient engine controls 112 and operating inputs 114. The real-time model 110 may capture full engine dynamic operating conditions 116 such as, but not limited to, inertial effects, the dynamics of induction and exhaust gas exchange, including turbocharging and EGR, full dynamics and full combustion effects. The operating inputs 114 may be received from engine sensors 122. These operating inputs 114 may include, but are not limited to, RPM, fueling rate, intake pressure, intake temperature, ambient pressure, rail pressure, selective catalytic reduction (SCR) inlet temperature, diesel particulate filter (DPF) inlet pressure, fuel injection timing, pilot injection quantity and EGR valve setting. These known operating inputs 114 are used in conjunction with the operating conditions 116, which are used to create setpoints 134 for further calculations that will be discussed in greater detail below. The operating conditions 116 may also include speed and fueling, to calculate instantaneous output torque, NOx, PM, CO, HC and CO₂ emissions levels at each of a multitude of time steps.

The exemplary MBC system may include additional requirements for high fidelity, fast response transient engine models 118, which can capture full engine dynamics across a wide range of transient time steps. Moreover, the engine modeling 118 may include a data-driven element for robustness, an adaptive learning capability, be computationally efficient (to allow predictions at rates much higher than real-time), and predict over multiple control time bases (milliseconds to seconds or minutes). The adaptive learning capability is through the adaptation 126 of fuel property variations, sensor drift and engine sensor actuator degradation. In addition, the modeling may be flexible and not associated with any fixed control strategy, and may accommodate crank-angle based, time-based, event based and interrupt-driven features.

After the initial operating inputs 114 from the engine data have been captured and analyzed, the dynamic or transient engine model 118 may be developed. The dynamic or transient engine model 118 may be created using a combination of physical and heuristic modeling to capture the full inertial, thermal, combustion and gas exchange dynamics of typical engine operation. This approach requires a range of timescales to be captured in the modeling, which in turn requires that the underlying data contain those transient features 118. The heuristic portion of the modeling effort may include a data driven learning process employing artificial neural networks 120 that are able to generalize predictions within the range of engine operation seen in the operating data inputs 114.

These models may include empirical neural networks trained with experimental data to recognize input-output relationships and the dynamics of engine systems. The complexity of the model depends on the number of layers, the number of neurons per layer and the number of inputs. The more layers and neurons, the more weights and biases are available to be trained with experimental data. Typical models will have 8-10 inputs (RPM, fueling rate, EGR rate, airflow rate, injection timing [BOI], injection pressure, intake temperature, intake pressure, RPM gradient, fueling rate gradient). The neural networks 120 may be created utilizing equation 1 and 2, listed below, which are configured to model the dynamic engine behavior. The dynamic engine behavior may have the following physical architecture: multi-layer perceptron (MLP, which is used to describe any feedforward network) with externally tapped time delays or history, 2 layers, with 20-25 nodes per layer, sigmoidal transfer functions, output linearization, and the equation utilizing a Levenberg-Marquardt training algorithm.

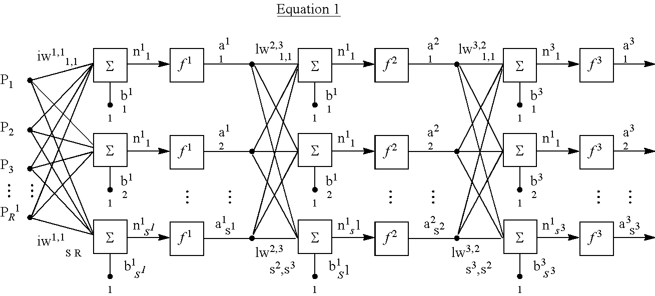

### Where:

P is the input vector (e.g., P1 would be RPM, P2=fueling rate, P3=injection timing, P4=% EGR, etc. . . . ). Pr is the last input, whichever variable it corresponds to. The input vector has a size of [R×1].
Each input (P vector) is multiplied by a weight (w). The result of that multiplication (w×P) is then an input to the summation block (Σ) where biases (the b vector) are added to the (w×P) term. The result is w×P+b. This is then used as an input to the transfer function f.

The output is:

y=f(Wp+b) Equation 2

### Where:

f is an exponential function and

y is the output or final result.

In forward transient modeling, the engine speed and fueling quantity are specified by an engine duty cycle, while the control parameters 162 are specified as a result of the later optimization stage 160. Thus the forward modeling 110 portion of the MBC system 100 is contingent on the prior knowledge of the engine control parameter outputs 142, which transforms the MBC control process into an iterative procedure.

Generally, dynamic engine models utilize the immediate operating history of the engine to determine the transient trajectory of the output parameters, thus creating a truly dynamic modeling environment. The specific extent of the history required is determined through an experimental modeling process to best match the underlying engine data.

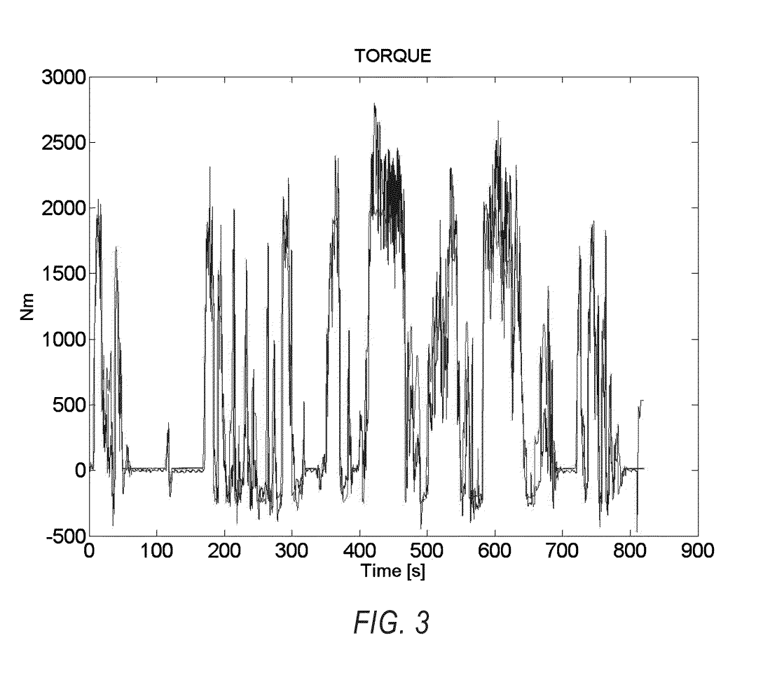

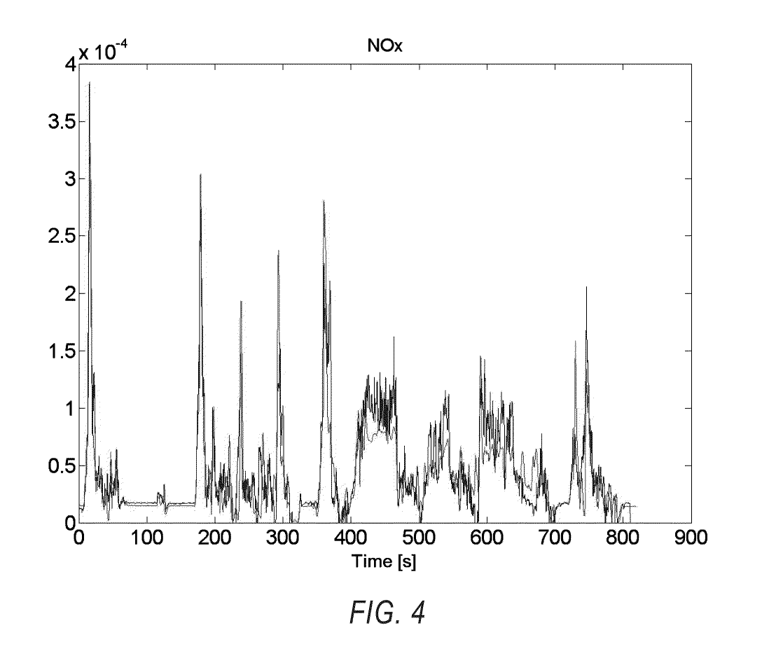

Turning now to FIGS. 3-7, there is shown graphical illustrations detailing the results of the forward dynamic engine modeling 110 for engine performance and emissions, using the FTP as the engine duty cycle with the control inputs as specified by the underlying engine operating data. These figures show the results of blind prediction, meaning that the specific data used here to show the prediction accuracy of the modeling does not form part of the data set used to develop the models. Data-driven artificial neural network models have an inherent averaging tendency that tends to smooth out the effects of measurement noise (of any origin) in the underlying data. However, it can be seen in FIGS. 4-8 that the predicted data in some cases shows a high frequency variation. This ‘variation’ is assumed to be real in origin, and is normally hidden by the sluggishness of emissions analyzer response and the smoothing tendencies thereof.

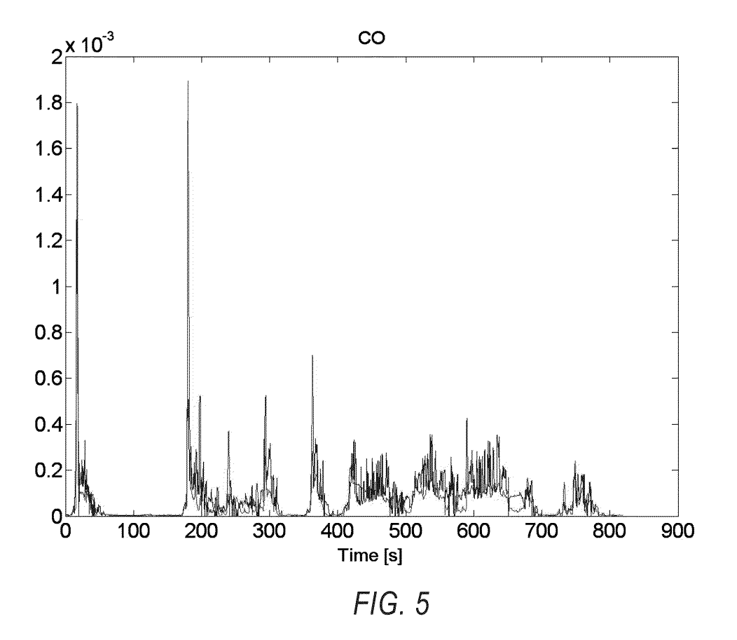

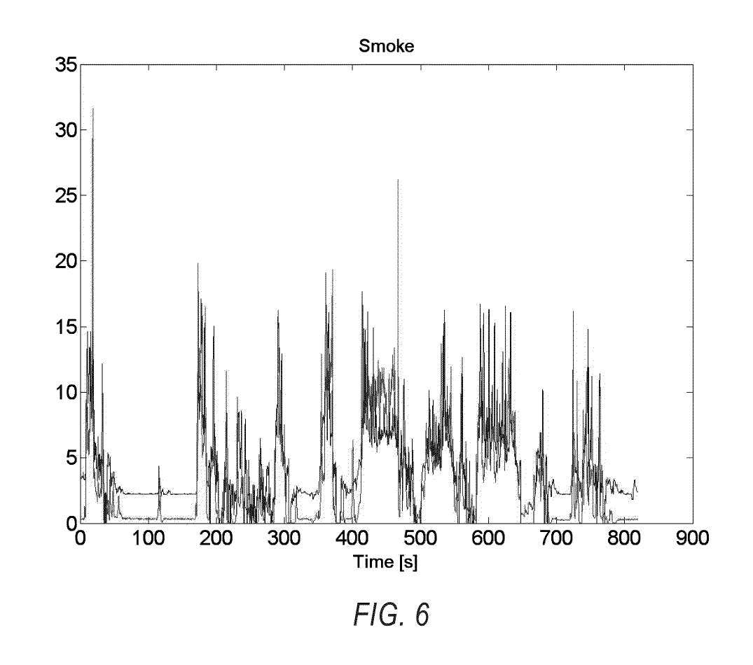

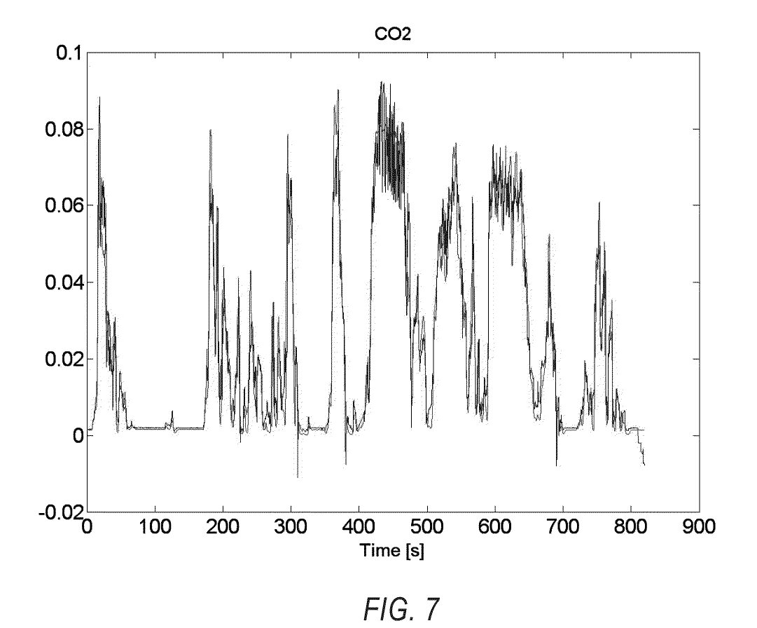

Specifically, FIG. 3 illustrates the predicted engine output torque using real-time dynamic engine modeling. As illustrated, the blue trace illustrates the MBC or predicted value, while the red indicates the measured data used in the underlying modeling. FIG. 4 illustrates the predicted NOx (nitrogen oxide) output using the real-time dynamic engine modeling, where the blue trace illustrates the MBC or predicted value, while the red indicates the measured data used in the underlying modeling. FIG. 5 illustrates the predicted CO (carbon monoxide) output using the real-time dynamic engine modeling, where the blue trace illustrates the MEG or predicted value, while the red indicates the measured data used in the underlying modeling. FIG. 6 illustrates the predicted engine smoke output using the real-time dynamic engine modeling, where the blue trace illustrates the MBC or predicted value, while the red indicates the measured data used in the underlying modeling. FIG. 7 illustrates the predicted CO₂ (carbon dioxide) output using the real-time dynamic engine modeling, where the blue trace illustrates the MBC or predicted value, while the red indicates the measured data used in the underlying modeling.

The model-based controller 140, utilizes inverse modeling to determine those engine control inputs 114 that may be required to give specific target engine outputs 142, either measured or predicted. The controller utilizes specific desired engine performance, emissions and fuel efficiency outputs 142 to dictate the required engine control inputs 114 that in turn result in those particular outputs 142. The inverse modeling must be high fidelity, dynamic and robust. Thus, to achieve the desired outputs 142 a multitude of input 114 combinations may be used to achieve the output 142 and must overcome what is known as the inversion problem. Specifically, a wide range of sets of control inputs 116 can provide the same engine outputs 142, and so a selection must be made between those feasible solutions.

As an example, for any particular engine speed and operating torque, there may be a number of potentially feasible combinations such as, but not limited to, injection timing and EGR rates that give rise to the same NOx levels. Thus, a choice has to be made in real-time between these competing feasible control input 114 sets to find the best combination, given the required target engine emissions and performance outputs 142, as well as considering the engine operating history and the practical slew rates of the active engine actuators 144. The result, from each iteration of the inverse modeling process, gives a single unique control input set that has to be checked and either accepted or rejected based on its feasibility. As in the forward transient engine modeling, artificial neural networks may be utilized for capturing the dynamic features of the inverse models. This is in addition to the benefits of the inherent learning capabilities, as discussed above.

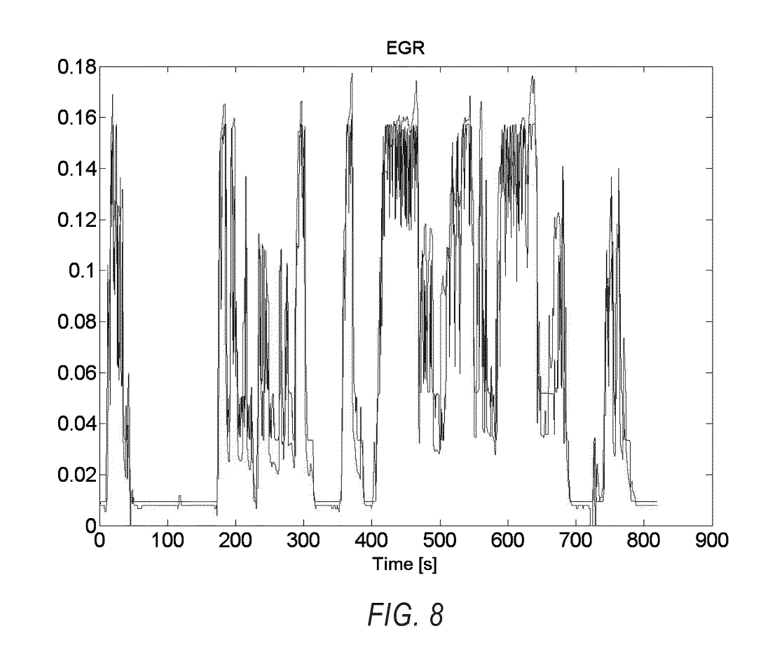

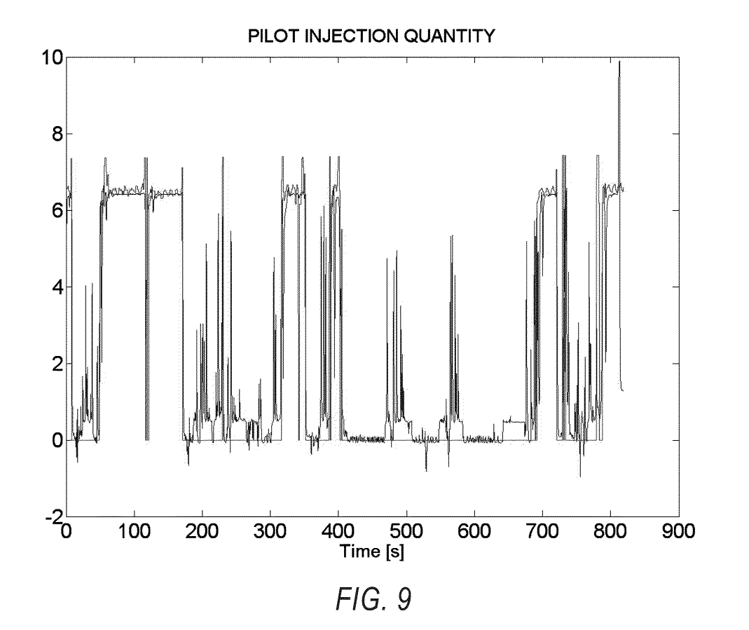

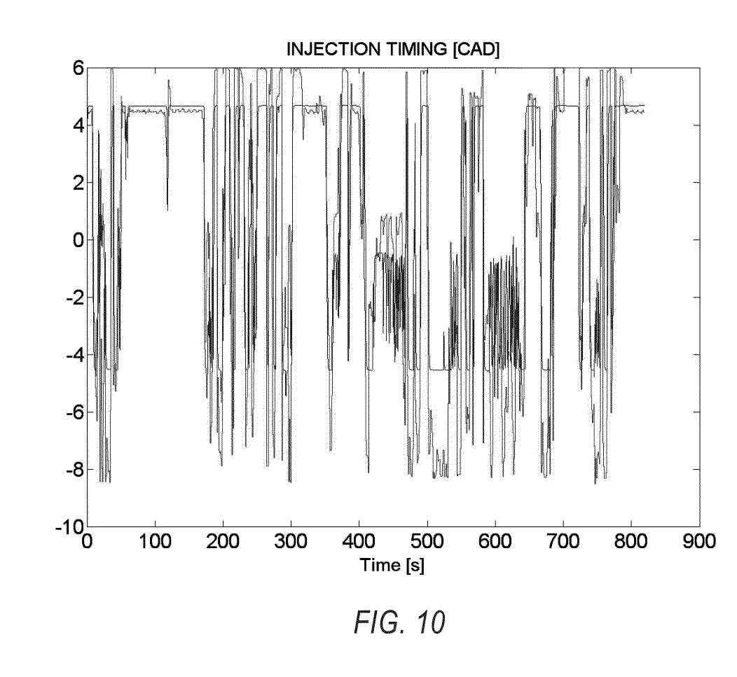

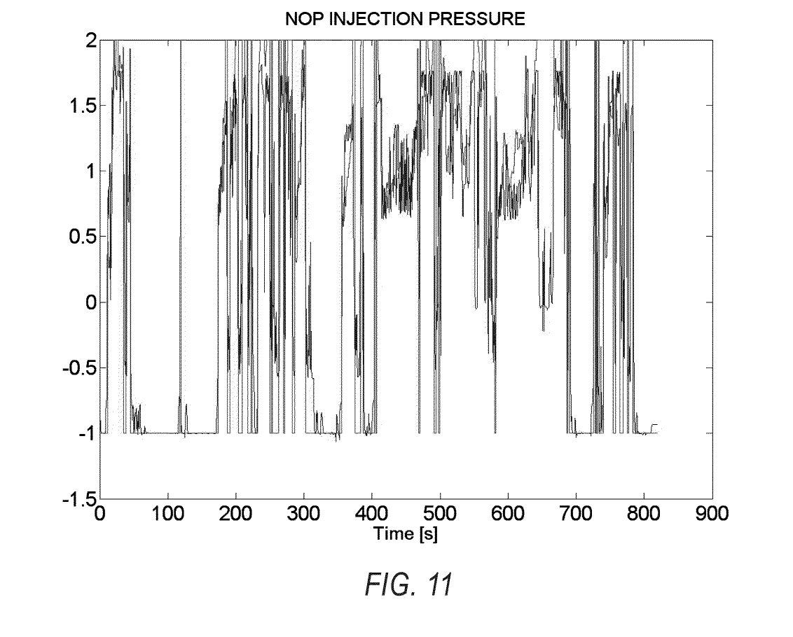

FIGS. 8-11 illustrate the results of the inverse dynamic model-based control calculations, using FTP as the engine duty cycle with the target engine outputs as specified by the underlying engine operating data. This inverse modeling relies on the target engine outputs as specified by the Real-Time Optimizer as detailed below. Specifically, FIG. 8 illustrates the predicted EGR rates using the real-time inverse modeling, where the blue trace illustrates the MBC or predicted value, while the red indicates the measured data used in the underlying modeling. FIG. 9 illustrates the predicted pilot injection quantities using the real-time inverse modeling, where the blue trace illustrates the MBC or predicted value, while the red indicates the measured data used in the underlying modeling. FIG. 10 illustrates the predicted injection timing using the real-time inverse modeling, where the blue trace illustrates the MBC or predicted value, while the red indicates the measured data used in the underlying modeling. FIG. 11 illustrates the predicted injection pressure using the real-time inverse modeling, where the blue trace illustrates the MBC or predicted value, while the red indicates the measured data used in the underlying modeling.

The MBC systems real-time optimizer (RTO) 160, provides real-time input to the MBC controller 120 for performance, emissions, and fuel consumption targets for control decision-making, to “steer” the engine control in real-time. Controlling the engine 130 in real-time helps to create a low NOx mode of operation, while maintaining and minimizing CO₂. The RTO 160 may allow for the real-time guided control of the engine, which eliminates the need for relying on extensive pre-mapped and pre-calibrated targets. In addition, the RTO 160 regulates engine emissions of NOx and PM, and the RTO 160 regulates real-time fuel consumption. This is accomplished by developing an optimizer target function that favors low NOx production over PM and CO production. For any combination of control inputs, the forward engine modeling predicts the engine performance and emissions outputs. The RTO then determines whether the predicted outputs meet the prescribed targets or not, and in the case that they do not, the inverse MBC element recalculates a new set of control inputs. This is performed iteratively for a limited number of iterations until the control inputs converge on a suitable set, or until the time available for calculation between successive control outputs expires.

The software element is designed to provide a set of engine output targets that can be tracked in real-time for use in the inverse modeling element. In other words a set of target values are provided to act as inputs in the inverse modeling. During engine operation, exhaust conditions are maintained to be conducive to the effective operation and regeneration of the downstream NOx and PM after-treatment 128 systems. The RTO 160 may include multiple logic components and control and optimization parameters such as, but not limited to, minimizing fuel consumption (BSFC), while meeting the constraints of not exceeding particular NOx and PM target values (that may vary in time) for engine-out emissions, minimizing urea usage for tailpipe out emissions, meeting a predetermined torque profile and not exceeding predetermined in-cylinder combustion pressure, exhaust temperature and turbocharger speed limits.

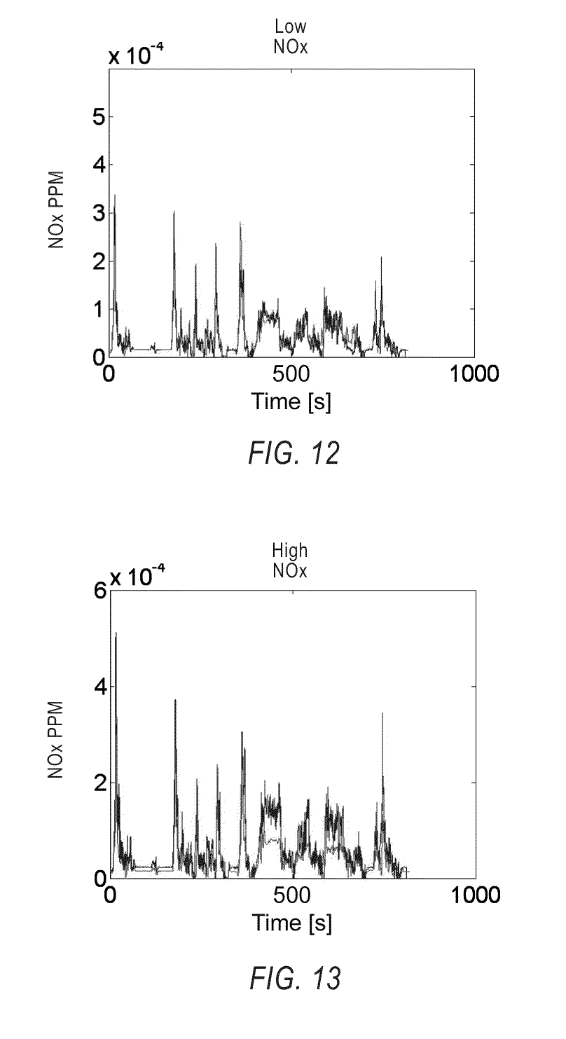

FIGS. 12-13, illustrate the NOx emissions profiles for at least two RTO scenarios, namely a low NOx and a high NOx set of targets. In the low NOx case, the real-time control was steered towards decreasing the instantaneous engine-out NOx emissions to 80% of the level corresponding to the base engine calibration values. The engine control presumably reduces the instantaneous (and hence integrated) NOx output at the expense of elevated PM emissions levels, but this experiment was performed to show the ability of the MBC system to ‘steer’ engine control in real-time towards any desired output. Specifically, FIG. 12 illustrates NOx emissions for a low NOx set of control targets employed by the RTO, where the blue line illustrates the “Optimized” set and the red line illustrates the “Baseline.” FIG. 13 illustrates NOx emissions for a high NOx set of control targets employed by the RTO, where the blue line illustrates the “Optimized” set and the red line illustrates the “Baseline.”

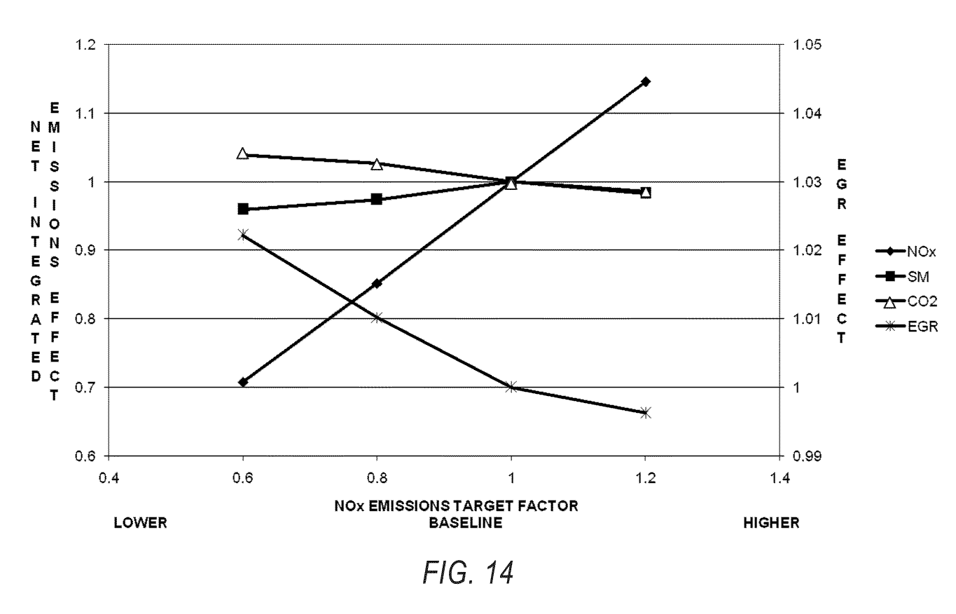

FIG. 14 illustrates the effect of varying NOx target levels on the integrated emissions values, as simulated across the FTP. For the NOx emissions, it can be seen that a target of 60% of baseline NOx actually results in an integrated NOx level of 70% of the baseline level—the discrepancy can be explained by the saturation of various control actuators, for example. Thus a target of 60% of NOx actually corresponds in reality to a 70% level, and a target of 120% results in a 115% level, thus validating the approach. Due to the requirements of maintaining adequate engine output torque and minimizing carbon dioxide emissions, the RTO action results in a modest decrease in integrated CO₂ emissions (of the order of 5%) for the same net work output across the cycle, thus demonstrating the ability of this approach to reduce fuel consumption while maintaining engine performance. Additionally, FIG. 14 illustrates further that the RTO reduces NOx emissions levels by demanding higher EGR levels, which corresponds well to an intuitive understanding of heavy-duty diesel engine operation.

The system 100 disclosed herein includes methods that have resulted in an approximate 2.5% reduction in fuel consumption over conventional techniques based on 2007 exhaust emission levels, with a significant reduction in engineering effort. Additionally, it should be known that this process is scalable and is capable of accommodating highly complex control, including after-treatment systems. Future applications to other engines, future engine technologies (such as systems with secondary energy recovery, alternative fuels, or hybrid systems operating on multiple power sources) are also possible.

With regard to the processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

It is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The words used herein are words of description, not words of limitation. Those skilled in the art recognize that many modifications and variations are possible without departing from the scope and spirit of the invention as set forth in the appended claims.

We claim:

1. An internal combustion engine controller, comprising:
at least one computational model;
at least one physical engine sensor input;
at least one predetermined control input; and
at least one output, wherein the computational model utilizes inverse modeling to determine the at least one control input.

2. The controller according to claim 1, wherein the controller is dynamic and includes at least one multi-dimensional, non-linear dynamic forward model for calculating engine parameters.

3. The controller according to claim 1, wherein the dynamic model captures at least one of real-time engine operating conditions and operating inputs from at least one engine sensor.

4. The controller according to claim 1, wherein the forward model includes at least one adaptive learning element, wherein calculations are made for the adaptation of at least one of fuel property variations, sensor drift and engine sensor actuator degradation.

5. The controller according to claim 1, wherein the forward model is flexible and accommodates at least one of crank-angle based, time-based, event based and interrupt-driven features.

6. The controller according to claim 1, wherein the computational model is empirical and trained with predetermined experimental data, and wherein the empirical computational model recognizes input-output relationships and the dynamics of the engine systems.

7. The controller according to claim 1, further comprising: at least one real-time optimizer, wherein the optimizer adjusts the engine control based on real-time condition inputs to the controller for at least one of a performance condition, an emission and a fuel consumption target.

8. The controller according to claim 7, wherein the real-time optimizer determines whether a predicted output meets a prescribed target through at least one iteration calculation.

9. The controller according to claim 7, wherein the real-time optimizer guides the controls of the engine based on real-time operating conditions.

10. The controller according to claim 7, wherein the real-time optimizer regulates at least one of NOx emissions, PM emissions and real-time fuel consumption.

11. A method of controlling an electronically controlled internal combustion engine, comprising:
providing at least one engine operating parameter;
utilizing a forward model to predict at least one engine parameter, wherein the at least one engine parameter includes at least one of an engine emission and engine fuel consumption;
optimizing real-time engine performance; and
utilizing an inverse model to determine at least one engine control input that results in a specific target engine output.

12. The method according to claim 11, further comprising:
calculating engine parameters utilizing at least one computation model, wherein the computation model includes at least one neural network.

13. The method according to claim 11, further comprising:
providing at least one engine sensor, wherein the engine sensor provides real-time engine operating conditions.

14. The method according to claim 11, further comprising:
providing at least one predetermined optimizer weight.

15. The method according to claim 11, further comprising:
minimizing a calibration effort, wherein an adaptation process is included, the process compensates the control input for at least one of a fuel property variation, a sensor drift and an engine sensor actuator degradation.

16. The method of claim 11, wherein the operating parameter is at least one of a rotational speed, a fueling rate, an exhaust gas recirculation rate, airflow rate, injection timing, injection pressure, intake temperature, intake pressure, revolutions per minute gradient and fueling rate gradient.

17. The method of claim 11, wherein the forward model is a high fidelity dynamic model, wherein the model predicts at least one of engine performance, emissions and operating states at high computational rates.
